(19) United States
(12) Patent Application Publication
(10) Pub. No.: US 2019/0111652 A1
(43) Pub. Date: Apr. 18, 2019

(54) ARCHITECTURAL RESIN PANEL WITH DECORATIVE SURFACE LAMINATIONS OR TEXTURES

(71) Applicant: 3form LLC, Salt Lake City, UT (US)

(72) Inventors: E. Egan Metcalf, Salt Lake City, UT (US); Cory M. Pymm, Salt Lake City, UT (US); David J. Martin, Salt Lake City, UT (US); Matthew T. Sutton, Salt Lake City, UT (US)

(21) Appl. No.: 16/160,893

(22) Filed: Oct. 15, 2018

Related U.S. Application Data
(60) Provisional application No. 62/571,936, filed on Oct. 13, 2017.

(51) Int. Cl. B32B 3/26; B32B 27/36; B32B 7/12; B32B 27/08; B32B 37/06; B32B 37/10

(52) U.S. Cl. CPC B32B 3/263; B32B 27/36; B32B 27/365; B32B 7/12; B32B 27/08; B32B 37/06; B32B 2607/00; B32B 2250/05; B32B 2250/244; B32B 2250/40; B32B 2307/412; B32B 2307/414; B32B 37/10

(57) ABSTRACT

A decorative resin panel having a thickness of at least about 1/16″ to about 2″, a length of at least about 3′ to about 5′, and a width of at least about 5′ to about 10′. The decorative resin panel can include a rigid thermoplastic resin sheet with a layer of decorative objects embedded on at least one surface. The layer of decorative objects can provide a variable, high relief tactile feature to the at least one surface of the decorative resin panel that corresponds to a shape of the layer of decorative objects. The resultant decorative resin panel can be used in both exterior and interior decorative and/or structural applications.

### CROSS-REFERENCE TO RELATED APPLICATIONS

The present application claims the benefit of priority to U.S. Provisional Patent Application No. 62/571,936, filed Oct. 13, 2017, entitled “Architectural Resin Panel with Decorative Surface Laminations or Textures,” the entire content of which is incorporated by reference herein.

### BACKGROUND OF THE INVENTION

### 1. The Field of the Invention

The present disclosure relates generally to systems, methods, and apparatus for preparing architectural panels.

### 2. Background and Relevant Art

Recent architectural designs have focused on decorative laminate panel products, such as glass or resin products, which can be used as decorative windows, and as partitions in offices and homes. In particular, decorative resin panels are now particularly popular compared with decorative glass panels because decorative resin panels can be manufactured to be more resilient than decorative glass panels, while having the same appearance. Manufacturers can also produce decorative resin panels at a lower cost than decorative glass panels.

Present resin products generally used for creating decorative resin panels comprise polyvinyl chloride, acrylic, poly(methylmethacrylate) or “PMMA”, poly(ethylene-co-cyclohexane 1,4-dimethanol terephthalate) or “PETG”, as well as other related polycarbonate materials. Each of the aforementioned resins can serve as an appropriate glass substitute. For example, polycarbonates, PETG, and PMMA are generally received for use in solid sheet form (i.e., extruded). An extruded sheet is generally a solid preformed sheet, such as a solid 4′×8′ PETG sheet (alternatively, 3′×5′ sheet, 5′×10′ sheet, etc.), which ultimately can form a surface of a decorative resin panel when the panel is in final form.

Decorative resin panels readily enable manufacturers to vary the design of their panels to follow architectural design trends. One such recent trend is using distinctive patterns embedded within resin panels. Typically, a manufacturer creates a decorative image layer by laminating decorative materials between opposing resin substrates. Through application of heat and pressure, the resin substrates melt around the decorative materials, and are viewable through the substrates.

Another way a manufacturer can create a decorative effect is to apply texture to a resin substrate. Textures generally vary from one to the next in terms of texture granule size/density, and occasionally texture pattern. A manufacturer typically applies a texture by applying a texture paper to an assembly of resin substrates, and then removes the texture paper after applying increased temperature and pressure. Manufacturers are, however, typically limited in the types of textures and texture patterns that they may apply to resin sheets by what patterns are available from the makers of texture papers.

Manufacturers of decorative resin panels generally lack the ability to customize the textures applied to their products unless they also manufacture texture papers. Further, texture paper cannot always produce natural-looking decorative resin panel products, which many consumers desire. In contrast, customers increasingly demand decorative resin panels with textures that are difficult if not impossible to produce in some cases using texture papers.

Accordingly, there are a number of disadvantages in the art that can be addressed.

### BRIEF SUMMARY OF THE INVENTION

Embodiments of the present invention solve one or more problems in the art with systems, methods, and apparatus configured to create decorative resin panels. In particular, embodiments of the present invention allow a manufacturer to use decorative objects, such as organic materials (e.g., twigs, leaves, branches, grasses, coffee beans) or other materials (e.g., rocks, crushed glass, textiles, metal rods, bars, etc.), for a decorative effect of a surface of a resin panel.

In at least one embodiment, a decorative resin panel comprises a thickness of at least about 1/16″ to about 2″, a length of at least about 3′ to about 5′, and a width of at least about 5′ to about 10′. The decorative resin panel can also comprise a rigid thermoplastic resin sheet having a layer of decorative objects embedded on at least one surface of the decorative resin panel. The decorative objects can provide a variable, tactile feature to the at least one surface of the decorative resin panel that corresponds to a shape of the layer of decorative objects.

In addition, at least one embodiment of the present invention comprises a layer of decorative objects positioned between opposing, thin, thermoplastic coating substrates. The shape of the layer decorative objects is displayed on a surface of the opposing, thin, thermoplastic coating substrates by virtue of the opposing, thin, thermoplastic coating substrates melting around and forming to the shape of the layer of decorative objects, such that the layer of decorative objects provides a variable, tactile feature to the surface of the opposing, thin, thermoplastic coating substrates.

Furthermore, at least one embodiment of the present invention comprises a process for the manufacture of a first and second decorative resin panel. The process can comprise preparing a layup assembly by positioning a layer of decorative objects between a thermoplastic substrate and a thin, thermoplastic coating substrate, and further surrounding the thermoplastic substrate and thin, thermoplastic coating substrate between opposing outer layers. At least one of the opposing outer layers can comprise a thermoplastic material. The process can also include processing the layup assembly such that the thermoplastic substrate and thin, thermoplastic coating substrate bond around the layer of decorative objects to form a first decorative resin panel with a variable, high relief tactile feature on a first surface of the first decorative resin panel that corresponds to a shape of the layer of decorative objects. A second decorative resin panel could also form from an impression of the variable, high relief tactile feature that corresponds to the shape of the layer of decorative objects forming on an inner surface of the thermoplastic outer layer.

Finally, in at least one embodiment, the present invention comprises a method of laminating decorative objects in a surface of a resin panel. In one implementation, the method can include preparing a layup assembly by positioning opposing first and second, thin, thermoplastic coating substrates around decorative objects. Then opposing first and second outer layers can be positioned around the opposing first and second, thin, thermoplastic coating substrates, respectively. The method can also comprise processing the layup assembly such that the first and second, thin, thermoplastic coating substrates melt around and form to the shape of the decorative objects. Lastly, the method can include disassembling the layup assembly by removing the opposing first and second outer layers from the resin panel with decorative objects on its surface.

Additional features and advantages of exemplary embodiments of the invention will be set forth in the description which follows, and in part will be obvious from the description, or may be learned by the practice of such exemplary embodiments. The features and advantages of such embodiments may be realized and obtained by means of the instruments and combinations particularly pointed out in the appended claims. These and other features will become more fully apparent from the following description and appended claims, or may be learned by the practice of such exemplary embodiments as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 depicts an exemplary decorative resin panel with a layer of decorative objects embedded on a surface thereof;

FIG. 2A illustrates a schematic overview of a process of creating a decorative resin panel with a layer of decorative objects embedded on both outside surfaces of the decorative resin panel, and two decorative resin panels each with an impression of a layer of decorative objects formed on a surface;

FIG. 2B illustrates a schematic overview of an alternative process of that illustrated in FIG. 2A of creating a decorative resin panel with a layer of decorative objects embedded on both outside surfaces of the decorative resin panel;

FIG. 2C illustrates a schematic overview of an alternative process of that illustrated in FIGS. 2A and 2B of creating a decorative resin panel wherein the shape of the layer decorative objects is displayed on both outside surfaces of the decorative resin panel;

FIG. 3 illustrates a chart of processing steps and corresponding temperature ranges for implementing a process for forming a decorative resin panel;

FIG. 4A depicts a decorative resin panel with a layer of decorative objects embedded on both outside surfaces of the decorative resin panel;

FIG. 4B depicts a decorative resin panel with a shape of a layer of decorative objects impressed on its surface;

FIG. 4C depicts a decorative resin panel wherein the shape of a layer of decorative objects is displayed on both outside surfaces of the decorative resin panel; and

FIG. 5 illustrates a flowchart comprising steps in a method for producing a decorative resin panel.

### DETAILED DESCRIPTION OF THE PREFERRED EMBODIMENTS

The present invention extends to systems, methods, and apparatus configured to create decorative resin panels. In particular, embodiments of the present invention allow a manufacturer to use decorative objects, such as organic materials (e.g., twigs, leaves, branches, grasses, coffee beans) or other materials (e.g., rocks, crushed glass, textiles, metal rods, bars, etc.), for decorative effect to the outside surface of resin panels.

Embodiments of the present invention allow manufacturers to produce natural-looking resin panels with high-relief textures. Because manufacturers are not limited to using texture paper to produce the resin panels, they can customize each resin panel based on customer demand. For example, the manufacturer can use organic and inorganic materials, or a combination thereof, to create the high-relief textures. Additionally, the manufacturer can adjust the transparency of the resin panels by altering the amount of organic or inorganic materials used to create the resin panels.

Embodiments of the present invention also allow a manufacturer to create one-sided resin panels, two-sided resin panels, or even resin panels with the shape of the high-relief textures impressed on at least one surface. The manufacturer can further customize the resin panels by adding dyes and color films, so nearly endless variations exist.

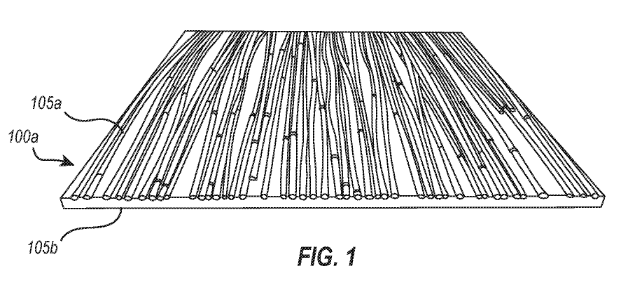

Along these lines, FIG. 1 depicts an exemplary decorative resin panel with a layer of decorative objects embedded on its surface 100a. As shown in FIG. 1, the layer of decorative objects is embedded on a first surface of the decorative resin panel 105a such that the layer of decorative objects provides a variable, high relief tactile feature to the first surface of the decorative resin panel 105a that corresponds to a shape of the layer of decorative objects.

One will appreciate that the present invention is not limited to the embodiment shown in FIG. 1. Rather, embodiments of the present invention are generally applicable to a wide range of resin panels, both planar and non-planar, of any size may be used. Further, while the decorative resin panel shown in FIG. 1 can be created using thatch reed, any mixture of decorative objects, organic or non-organic, could be used to achieve a desired design. For example, the manufacturer may elect to use other organic or inorganic materials other than those items shown herein, including but not limited to metal wire or bar, rocks, soft vegetation (e.g., fruits or vegetables), etc.

Further, FIG. 1 illustrates an embodiment in which there is not a layer of decorative object embedded on a second surface of the decorative resin panel 105b. One skilled in the art, however, will appreciate that the present invention is not limited to the decorative resin panel with a layer of decorative objects is embedded on its surface 100a shown in FIG. 1, wherein the layer of decorative objects embedded on the first surface of the decorative resin panel 105a, and the second surface of the decorative resin panel 105b has no tactile feature. A decorative resin panel with a layer of decorative objects embedded on the first surface of the decorative resin panel 105a and a layer of decorative object embedded on the second surface of the decorative resin panel 105b is in accordance with this invention.

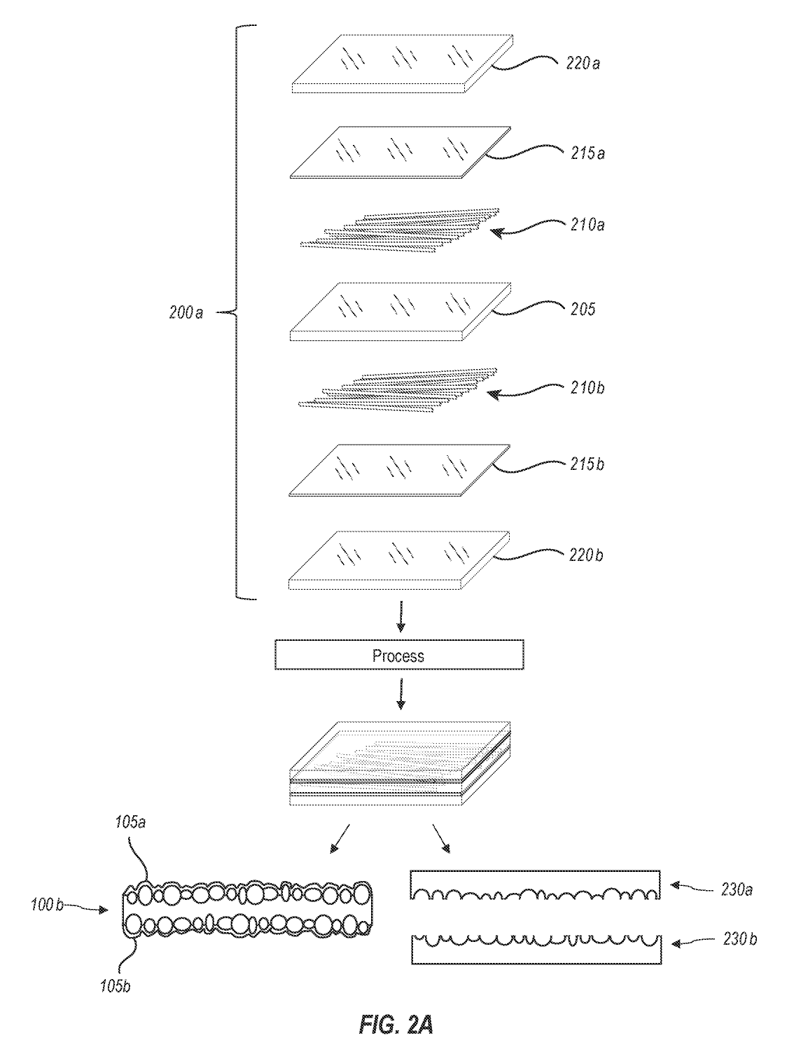

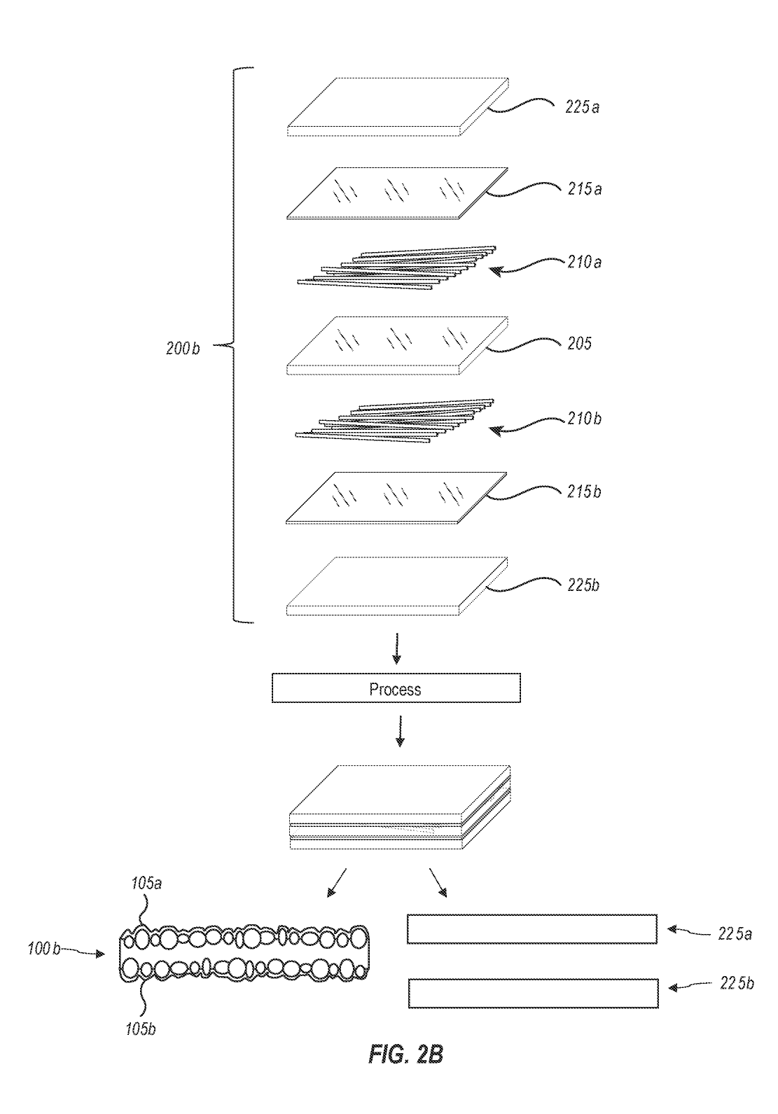

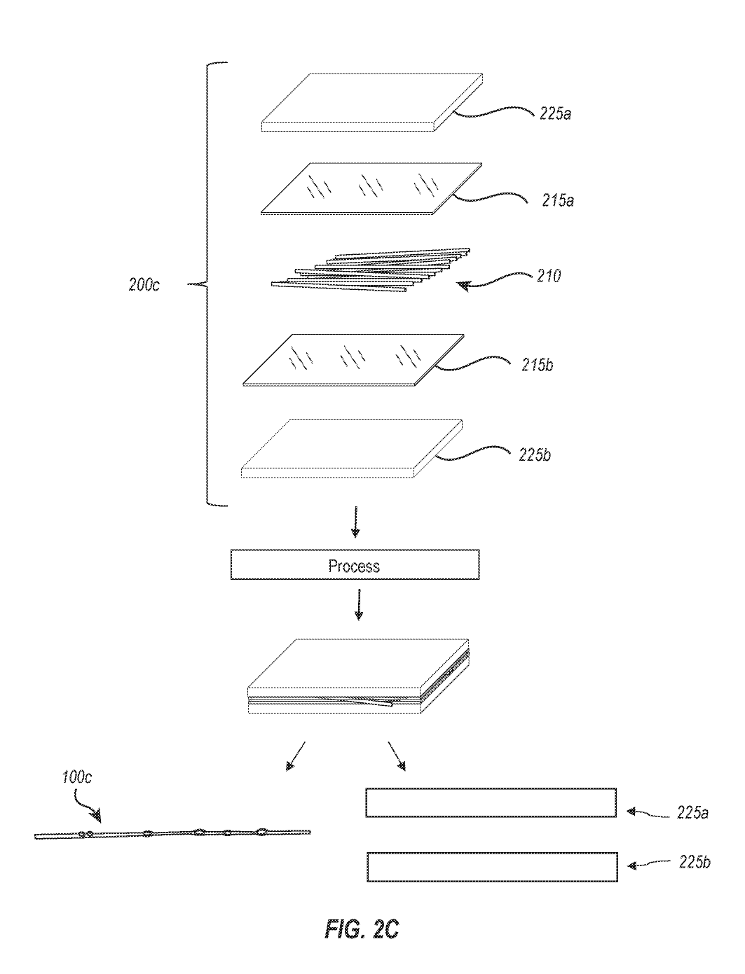

FIGS. 2A-2C illustrate schematic overviews of processes of creating various embodiments of a decorative resin panel. In particular, FIG. 2A shows that the manufacturer can create a layup assembly 200a comprising a thermoplastic substrate 205 surrounded by opposing first and second layers of decorative objects 210a and 210b, further surrounded by opposing first and second, thin, thermoplastic coating substrates 215a and 215b, finally surrounded by opposing first and second outer thermoplastic substrates 220a and 220b. The manufacturer may also add a release film or coating layer between the first outer thermoplastic substrate 220a and first, thin, thermoplastic coating substrate 215a, and/or between the second outer thermoplastic substrate 220b and second, thin, thermoplastic coating substrate 215b. The release film or coating layer can prevent the first or second outer thermoplastic substrates 220 from bonding to first or second, thin, thermoplastic coating substrates 215, respectively, during processing.

Similarly, FIG. 2B shows that the manufacturer can create a layup assembly 200b comprising a thermoplastic substrate 205 surrounded by opposing first and second layers of decorative objects 210a and 210b, and further surrounded by opposing first and second, thin, thermoplastic coating substrates 215a and 215b. However, rather than use first and second outer thermoplastic substrates 220a and 220b, the final outside layers in the layup assembly 200b in FIG. 2B are opposing first and second sponge layers 225a and 225b.

FIG. 2C shows an alternative layup assembly 200c comprising a layer of decorative objects 210 surrounded by opposing first and second, thin, thermoplastic coating substrates 215a and 215b, and further surrounded by opposing first and second sponge layers 225a and 225b.

One will appreciate that in additional or alternative embodiments other than those shown in FIGS. 2A-2C, the manufacturer can also include one or more adhesive layers (e.g., PET, PMMA, or PVC adhesive films or adhesive sprays layers). In at least one embodiment of the present invention, the layup assembly 200a-200c includes a metal plate as a base layer that is subject to repeated stresses from continual direct contact with stationary press plates. The manufacturer may use a pressure pad to help equalize the pressure on, and temperature of, the other layers of the layup assembly, thereby helping form a highly uniform decorative resin panel 100 in final form. Finally, the manufacturer may choose to position a paper layer (e.g., acrylic paper) with an adhesive surface (e.g., acrylic adhesive) so it will adhere to any outer surface of the decorative resin panel 100. The paper layer removably adheres to the final decorative product during the setting process, and the manufacturer can peel the paper layer away from the decorative laminate panel before end use.

In at least one exemplary embodiment of the present invention, the thermoplastic substrate 205, the opposing first and second, thin, thermoplastic coating substrates 215a and 215b, and the opposing first and second outer thermoplastic substrates 220a and 220b comprise transparent or translucent extruded copolyesters containing repeating units of terephthalic acid residues (e.g., PETG), ethylene glycol residues, and cyclohexanedimethanol residues.

The thermoplastic substrate 205, the opposing first and second, thin, thermoplastic coating substrates 215a and 215b, and the opposing first and second outer thermoplastic substrates 220a and 220b can also comprise extruded polycarbonate. The term “polycarbonate” refers generally to thermoplastic, aromatic polymers including homopolycarbonates, copolycarbonates, copolyestercarbonates and mixtures thereof having average molecular weights of between approximately 8,000 amu (atomic mass units) and 205,000 amu. Preferably, polycarbonates for use with some embodiments of the present invention have molecular weights of between approximately 20,000 amu and 80,000 amu, and have an instrinsic viscosity (I.V.) of approximately 0.40 to approximately 1.5 dl/g as measured in methylene chloride at approximately 25° C.

In at least one embodiment of the present invention, the thermoplastic substrate 205, the opposing first and second, thin, thermoplastic coating substrates 215a and 215b, and the opposing first and second outer thermoplastic substrates 220a and 220b all comprise different, yet compatible (e.g., thermal compatibility, miscibility) materials. In an alternative or additional embodiment, in the layup assembly 200a illustrated in FIG. 2A, the thermoplastic substrate 205, and the opposing first and second, thin, thermoplastic coating substrates 215a and 215b comprise PETG, and the opposing first and second outer thermoplastic substrates 220a and 220b comprise another thermoplastic material with a glass transition temperature and melt flow temperature similar to that of PETG.

The opposing first and second sponge layers 225a and 225b used in the layup assemblies 200b and 200c in FIGS. 2B and 2C, respectively, can comprise any rubberized foam or sponge material. In at least one embodiment of the present invention, the opposing first and second sponge layers 225a and 225b comprise silicone.

Further, one skilled in the art will appreciate that although FIG. 2C shows an assembly wherein the manufacturer used opposing first and second sponge layers 225a and 225b in the assembly layup 200c, the invention is not so limited. For example, the manufacturer can also use opposing first and second outer thermoplastic substrates 220a and 220b, as in layup assembly 200a in Figure A.

The thermoplastic substrate 205 used in the layup assemblies 200a and 200b has a thickness depending on the desired thickness of the final decorative laminate panels. One will appreciate that the opposing first and second, thin, thermoplastic coating substrates 215a and 215b in the layup assemblies 200a-200c can have a thickness depending on the type of decorative objects used in the opposing first and second layers of decorative objects 210a and 210b (FIGS. 2A and 2B), or the layer of decorative objects 210 (FIG. 2C).

In at least one embodiment of the present invention, the thermoplastic substrate 205 has a thickness between about 1/32^{nd} inch and 1 inch, preferably between about 1/16^{th} and ½^{nd} inch, and the opposing first and second thermoplastic coating substrates 215a and 215b have a thickness between about 1/32nd and 1 inch, preferably between about 1/32^{nd} and 1/16^{th} inch. Considerations for choosing thinner or thicker opposing outer first and second thermoplastic substrates 220a and 220b also depend on the thickness of the opposing first and second layers of decorative objects 210a and 210b (FIG. 2A).

The processes shown in FIGS. 2A and 2B both produce a decorative resin panel with a layer of decorative objects embedded on the first and second surface 105a and 105b of the decorative resin panel 100b. When the layup assembly 200a or 200b is processed, the thermoplastic substrate 205 binds to the opposing first and second, thin, thermoplastic coating substrates 215a and 215b, and the opposing first and second, thin, thermoplastic coating substrates 215a and 215b mold to the shape of the opposing first and second layers of decorative objects 210a and 210b, respectively. The first and second layers of decorative objects 210a and 210b provide variable, high relief tactile features to the first and second surfaces 105a and 105b of the decorative resin panel 100b that correspond to a shape of the first and second layers of decorative objects 210a and 210b, respectively.

Although in FIGS. 2A and 2B the opposing first and second layers of decorative objects 210a and 210b comprise the same material, in at least one embodiment, the first layer of decorative objects 210a could comprise a first material or a combination thereof, and the second layer of decorative objects 210b could comprise a second material or a combination thereof. Therefore, the first surface 105a of the decorative resin panel 100b could provide a variable, high relief tactile feature that corresponds to a shape of the first material or combination thereof, and the second surface 105b of the decorative resin panel 100b could provide a variable, high relief tactile feature that corresponds to a shape of the second material or combination thereof.

The process shown in FIG. 2A also produces a first and second decorative resin panel with a shape of a layer of decorative objects impressed on one of its surfaces 230a and 230b. During processing, the first layer of decorative objects 210a impresses its shape on an inside surface of the first outer thermoplastic substrate 220a, and the second layer of decorative objects 210b impresses its shape on an inside surface of the second outer thermoplastic substrate 220b. As stated above, to prevent the opposing first and second outer thermoplastic substrates 220a and 220b from bonding to the opposing first and second, thin, thermoplastic coating substrates 215a and 215b, respectively, during processing, the manufacturer may add a release film or coating layer between the first outer thermoplastic substrate 220a and first, thin, thermoplastic coating substrate 215a. Additionally or alternatively, the manufacturer can position the release film or coating layer between the second outer thermoplastic substrate 220b and second, thin, thermoplastic coating substrate 215b.

In at least one embodiment, the manufacturer can form the first and second decorative resin panels with the shape of a layer of decorative objects impressed on their surfaces 230a and 230b, and then sell the resin panels as decorative panels, or reuse the panels in another layup assembly or process. The manufacturer can similarly reuse opposing first and second sponge layers 225a and 225b of layup assemblies 200b and 200c in FIGS. 2B and 2C, respectively, in another layup assembly or process.

The process shown in FIG. 2C produces a decorative resin panel wherein the shape of the layer decorative objects is displayed on both outside surfaces of the decorative resin panel 100c. When the layup assembly 200c is processed, the first, thin, thermoplastic coating substrate 215a is bonded to the second, thin, thermoplastic coating substrate 215b with the layer of decorative object 210 positioned between the opposing first and second, thin, thermoplastic coating substrates 215a and 215b. The shape of the layer decorative objects 210 is displayed on a surface of the opposing first and second, thin, thermoplastic coating substrates 215a and 215b by virtue of the opposing first and second, thin, thermoplastic coating substrates 215a and 215b melting around and forming to the shape of the layer of decorative objects 210, such that the layer of decorative objects 210 provides a variable, tactile feature to the surface of the opposing first and second, thin, thermoplastic coating substrates 215a and 215b.

FIG. 3 illustrates a chart 300 outlining the primary processing steps and corresponding pressure and temperature ranges for implementing a process for forming a decorative resin panel 100. The temperatures and pressures illustrated in FIG. 3 are specific to extruded PETG sheets, and extruded copolyester sheets having similar properties. One will appreciate that the present invention is not limited to the processing steps outlined in FIG. 3. Any processing method may be used in embodiments of the present invention that allow thin, thermoplastic coating substrates 215 to form around a layer of decorative objects 210.

As previously indicated, the manufacturer places the layup assembly (e.g., 200a, 200b, 200c) in a thermosetting environment (e.g., stationary press) so that the assembly can undergo a series of pressure and temperature changes. As shown in FIG. 3, in a first step 310, for example, the manufacturer can apply between approximately 5 to 10 psi of pressure on layup assembly 200, and raise the temperature from between approximately 70° F. to approximately 180° F. In layup assemblies 200a in FIG. 2A and 200b in FIG. 2B, the thermoplastic substrate 205 and the opposing first and second, thin, thermoplastic coating substrates 215a and 215b begin to soften around the opposing first and second layers of decorative objects 210a and 210b. In layup assembly 200c in FIG. 2C, the opposing first and second, thin, thermoplastic coating substrates 215a and 215b being to soften around the layer or decorative objects 210.

The manufacturer can then perform a second step 320 of raising the pressure to between approximately 30-40 psi, and raising the temperature between approximately 180° F. and approximately 230° F. In layup assemblies 200a in FIG. 2A and 200b in FIG. 2B, the thermoplastic substrate 205 and the opposing first and second, thin, thermoplastic coating substrates 215a and 215b soften sufficiently so that the opposing first and second layers of decorative objects 210a and 210b are completely enveloped by the thermoplastic substrate 205 and the opposing first and second, thin, thermoplastic coating substrates 215a and 215b.

In layup assembly 200a in FIG. 2A, the surfaces of the opposing first and second outer thermoplastic substrates 220a and 220b also soften sufficiently to form around the shape of the opposing first and second layers of decorative objects 210a and 210b through the opposing first and second, thin, thermoplastic coating substrates 215a and 215b. A release film or coating layer can prevent bonding between the opposing first and second, thin, thermoplastic coating substrates 215a and 215b and the opposing first and second outer thermoplastic substrates 220a and 220b, respectively.

In layup assembly 200c in FIG. 2C, the opposing first and second, thin, thermoplastic coating substrates 215a and 215b soften sufficiently so that the layer of decorative objects 210 is completely enveloped by the opposing first and second, thin, thermoplastic coating substrates 215a and 215b.

The manufacturer then finalizes the decorative laminate panel in steps 330 and 340, whereby the layup assembly 200a, 200b, or 200c is pressed into final form 330, and then cooled 340. For example, in step 330, the manufacturer can raise the pressure to approximately 92 psi, and raise the temperature to between approximately 230° F. and approximately 240° F. The manufacturer holds this temperature and pressure for a time of up to approximately 5 minutes or less, until the assembly is pressed into final form. Thereafter, the manufacturer cools the layup assembly 200a, 200b, or 200c to a temperature approaching 70° F., and removes the processed layup assembly 200a, 200b, or 200c from the stationary press.

Of course, the manufacturer can also adjust the foregoing temperatures and pressures, as described herein, in order to suit the melting points of other extruded materials. With respect to extruded polycarbonate, for example, the manufacturer may adjust the temperatures described for the table in FIG. 3 by adding approximately 120° F. to many of the higher-end temperatures.

As such, FIG. 3 shows that a first step 310 can comprise implementing a pressure of approximately 5-10 psi on an extruded polycarbonate assembly, and raising the temperature from approximately 70-80° F. to approximately 300° F. FIG. 3 also shows that a second step 320 can comprise implementing a pressure of approximately 30-40 psi on the extruded polycarbonate assembly, and raising the temperature from approximately 300° F. to 350° F.

In addition, FIG. 3 shows that a step 330 can comprise implementing a pressure of approximately 92 psi, and raising the temperature from approximately 350° F. to approximately 360° F. Finally, FIG. 3 shows that a finishing step 340 can comprise holding a pressure of approximately 92 psi on the polycarbonate assembly, and reducing the temperature from 360° F. to as low as approximately 70°−80° F. Of note, the low-end values of 70°-80° are typically lowest approximations of a final or initial cooling value, and may be higher or lower as appropriate without affecting the quality of the decorative laminate product.

Accordingly, one will appreciate that the foregoing pressure and temperature values for extruded PETG sheets and extruded polycarbonate sheets are merely exemplary embodiments of the invention. Even further, while the previously described temperatures and pressures relate to at least one embodiment of the present invention, one will appreciate that existing manufacturers can implement the above mentioned temperatures within a range of ±approximately 15°−20° F., depending on the particular embodiment. One will appreciate that the manufacturer need not ensure that the temperatures and pressures of a given process reach the previously described pressures and temperatures exactly. In particular, the manufacturer need only ensure that the temperatures and pressures of a given process are in a suitable range for softening and melting the respective thermoplastic substrates.

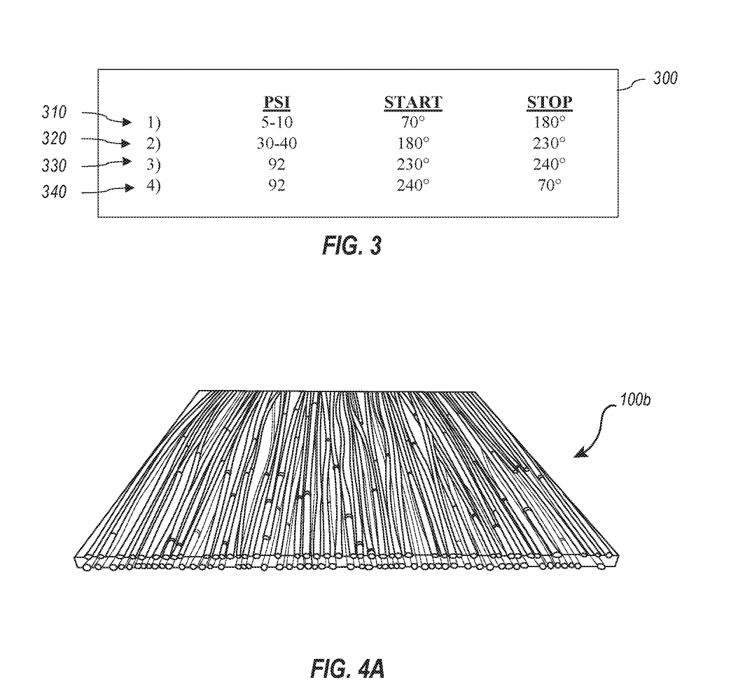

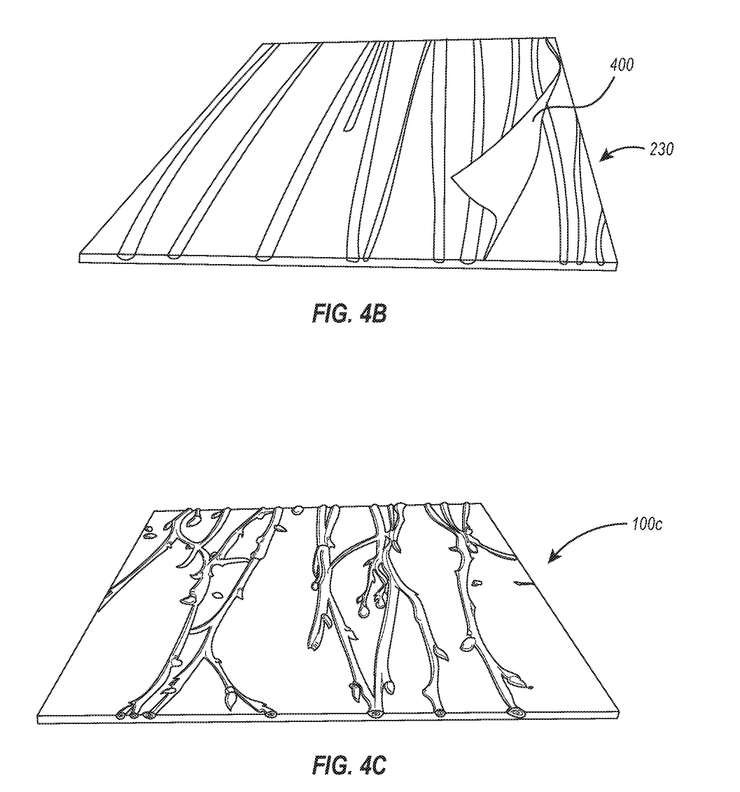

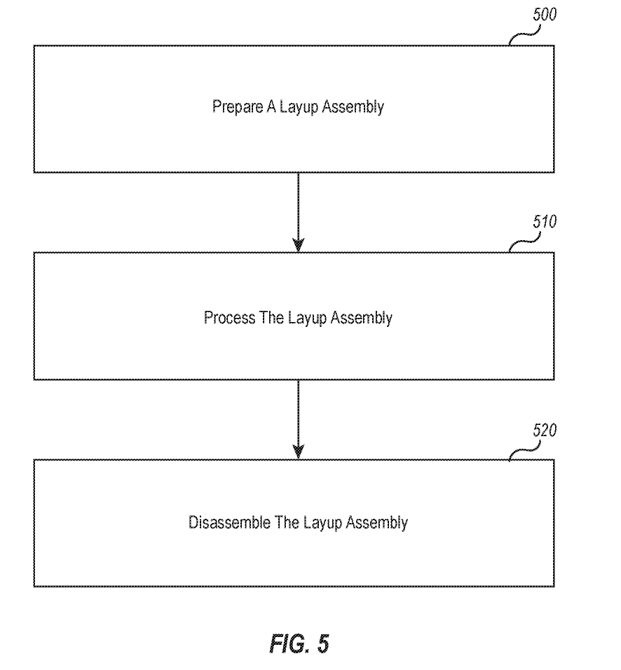

FIG. 4A depicts a decorative resin panel with a layer of decorative objects embedded on both outside surfaces of the decorative resin panel 100b, as produced from the layup assemblies 200a in FIG. 2A, and 200b in FIG. 2B. As shown in FIG. 4A, the opposing first and second, thin, thermoplastic coating substrates are thin enough that the surface of the resultant resin panel is textured by the shape of the opposing first and second layers of decorative objects, despite the fact that the opposing first and second, thin, thermoplastic coating substrates cover the opposing first and second layers of decorative objects, respectively.

FIG. 4B depicts a decorative resin panel with a shape of a layer of decorative objects impressed on its surface 230, as produced from a layup assembly similar to 200a in FIG. 2A. The thin, thermoplastic coating substrate is thin enough that the shape of the layer of decorative objects can be impressed on the inside surface of the outer thermoplastic substrate through the thin, thermoplastic coating substrate. As shown in FIG. 4B, a release film 400 can be attached to the decorative resin panel with the shape of the layer of decorative objects impressed on its surface 230 after processing.

One skilled in the art will note that FIGS. 4A and 4B could not be made in the same layup assembly because the shape of the layer of decorative objects impressed on the surface of decorative resin panel 230 in FIG. 4B do not correspond to the textured shape embedded on the surface of the decorative panel 100b in FIG. 4A.

FIG. 4C depicts a decorative resin panel wherein the shape of the layer of decorative objects is displayed on both outside surfaces of the decorative resin panel 100c, as produced from layup assembly 200c in FIG. 2C. FIG. 4C shows that the shape of the layer decorative objects is displayed on a surface of the opposing first and second, thin, thermoplastic coating substrates by virtue of the opposing first and second, thin, thermoplastic coating substrates melting around and forming to the shape of the layer of decorative objects, such that the layer of decorative objects provides a variable, tactile feature to the surface of the opposing first and second, thin, thermoplastic coating substrates.

FIG. 5 illustrates a flowchart comprising steps in a method for producing a decorative resin panel 100. As illustrated in FIG. 5, in at least one embodiment of the present invention, the manufacturer may perform a step 500 of preparing a layup assembly by positioning opposing first and second thermoplastic coating substrates around decorative objects, and further surrounding the opposing first and second thermoplastic coating substrates with opposing first and second outer layers, respectively.

FIG. 5 further shows that the manufacturer can perform a step 510 of processing the layup assembly in a manner that the decorative objects bond to the first and second thermoplastic coating substrates to form a decorative resin panel. For example, processing the layup assembly using the temperatures and pressures outlined in FIG. 3.

Finally, FIG. 5 shows that the manufacturer can perform a step 520 of disassembling the layup assembly by removing the opposing first and second outer layers from the decorative resin panel to produce a decorative resin panel 100 that has a thickness of at least about 1/16″ to 2″, a length of at least about 3′ to about 5′, and a width of at least about 6′ to about 9′. The resultant decorative resin panel 100 is a textured, architectural panel.

Embodiments of the present invention allow manufacturers to produce nearly endless variations of decorative resin panels with a high-relief texture, based on customer demand. Manufacturers can use organic and inorganic material, or a combination thereof, to create the high-relief texture. Embodiments of the present invention allow a manufacturer to create one-sided resin panels, two-sided resin panels, or even resin panels with the shape of the high-relief texture impressed on at least one surface. The decorative resin panel can be suitable for any number of outdoor or indoor architectural purposes.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

We claim:

1. A decorative resin panel comprising:
a decorative resin panel having a thickness of at least about 1/16″ to about 2″, a length of at least about 3′ to about 5′, and a width of at least about 5′ to about 10′;
wherein:
the decorative resin panel comprises a rigid thermoplastic resin sheet having a layer of decorative objects embedded on a surface thereof, and
the layer of decorative objects provides a variable, high relief tactile feature to the surface of the decorative resin panel that corresponds to a shape of the layer of decorative objects.

2. The decorative resin panel of claim 1, further comprising:
a thermoplastic substrate, having a first and second side; and
a thin, thermoplastic coating substrate;
wherein:
the thin, thermoplastic coating substrate is bonded to the first side of the thermoplastic substrate with the layer of decorative objects positioned between the thin, thermoplastic coating substrate and the first side of the thermoplastic substrate, and
the thin, thermoplastic coating substrate molds to the shape of the layer of decorative objects and provides a barrier thereto.

3. The decorative resin panel of claim 2, further comprising:
a second, thin, thermoplastic coating substrate; and
a second layer of decorative objects positioned between the second, thin, thermoplastic coating substrate and the second side of the thermoplastic substrate,
wherein:
the second, thin, thermoplastic coating substrate is bonded to the second side of the thermoplastic substrate,
the second, thin, thermoplastic coating substrate molds to the shape of the second layer of decorative objects and provides a barrier thereto.

4. The decorative resin panel of claim 2, wherein the thermoplastic substrate and the thin, thermoplastic coating substrate are composed of PETG, polycarbonate, or a composite thereof.

5. The decorative resin panel of claim 2, further comprising an adhesive layer.

6. The decorative panel of claim 2, wherein the thermoplastic substrate has a thickness of at least about 1/32″ to about 1″.

7. The decorative panel of claim 3, wherein the thin, thermoplastic coating substrate and the second, thin, thermoplastic coating substrate each has a thickness of at least about 1/32″ to about 1″.

8. A decorative resin panel comprising:
a layer of decorative objects; and
opposing first and second, thin, thermoplastic coating substrates;
wherein:
the first, thin, thermoplastic coating substrate is bonded to the second, thin, thermoplastic coating substrate with the layer of decorative objects positioned between the opposing first and second, thin, thermoplastic coating substrates,
each of the opposing first and second, thin, thermoplastic coating substrates has a thickness of at least about 1/32″ to about 1″,
the shape of the layer of decorative objects is displayed on a surface of the opposing first and second, thin, thermoplastic coating substrates and provides a variable, tactile feature to the surface of the opposing first and second, thin, thermoplastic coating substrates, and
the variable, tactile feature on the surface of the opposing first and second, thin, thermoplastic coating substrates corresponds to the shape of the layer of decorative objects.

9. A process for the manufacture of a first and second decorative resin panel, the process comprising:
preparing a layup assembly by positioning a layer of decorative objects between a thin, thermoplastic coating substrate, and a thermoplastic substrate, which is rigid, and further surrounding the thin, thermoplastic coating substrate and the thermoplastic substrate between opposing first and second outer layers, respectively,
wherein the first outer layer comprises a thermoplastic material; and
processing the layup assembly such that the thermoplastic substrate and thin, thermoplastic coating substrate bond around the layer of decorative objects to form a first decorative resin panel with a variable, high relief tactile feature on a first surface of the first decorative resin panel that corresponds to a shape of the layer of decorative objects,
wherein:
an impression of the variable, high relief tactile feature that corresponds to the shape of the layer of decorative objects forms on an inner surface of the first outer layer to form a second decorative resin panel,
the first decorative resin panel has a thickness of at least about 1/16″ to about 2″, a length of about 3′ to about 5′, and a width of about 5′ to about 10′, and
the second decorative resin panel has a thickness of at least about 1/32″ to about 1″, a length of about 3′ to about 5′, and a width of about 5′ to about 10′.

10. The process for the manufacture of a first and second decorative resin panel of claim 9, wherein the process further comprises:
positioning a release film or coating layer directly between the thin, thermoplastic coating substrate and the first outer layer, wherein the release film or coating layer prevents the thin, thermoplastic coating substrate and the first outer layer from bonding.

11. The process for the manufacture of a first and second decorative resin panel of claim 9, wherein the process further comprises:
positioning a second layer of decorative objects directly against the thermoplastic substrate; and
positioning a second, thin, thermoplastic coating substrate between the second layer of decorative objects and the second outer layer,
wherein:
the second outer layer comprises a thermoplastic material,
the thermoplastic substrate and the second, thin, thermoplastic coating substrate bond around the second layer of decorative objects to provide the first decorative resin panel with a variable, high relief tactile feature on a second surface of the first decorative resin panel that corresponds to a shape of the second layer of decorative objects,
an impression of the variable, high relief tactile feature that corresponds to the shape of the second layer of decorative objects forms on an inner surface of the second outer layer to form a third decorative resin panel, and
the third decorative resin panel has a thickness of at least about 1/32″ to about 1″, a length of about 3′ to about 5′, and a width of about 5′ to about 10′.

12. The process for the manufacture of a first and second decorative resin panel of claim 11, wherein the process further comprises:
positioning a second release film or coating layer directly between the second, thin, thermoplastic coating substrate and the second outer layer, wherein the second release film or coating layer prevents the second, thin, thermoplastic coating substrate and the second outer layer from bonding.

13. The process for the manufacture of a first and second decorative resin panel of claim 9, wherein the process further comprises:
softening the layup assembly at a first pressure and temperature such that the thermoplastic substrate and thin, thermoplastic coating substrate begin to surround the layer of decorative objects;
further softening the layup assembly at a second pressure and temperature such that the thermoplastic substrate and thin, thermoplastic coating substrate soften sufficiently to completely surround the layer of decorative objects; and
pressing the layup assembly at a third pressure and temperature.

14. The process for the manufacture of a first and second decorative resin panel of claim 11, wherein the process further comprises:
softening the layup assembly at a first pressure and temperature such that the thermoplastic substrate and second, thin, thermoplastic coating substrate begin to surround the second layer of decorative objects;
further softening the layup assembly at a second pressure and temperature such that the thermoplastic substrate and second, thin, thermoplastic coating substrate soften sufficiently to completely surround the second layer of decorative objects; and
pressing the layup assembly at a third pressure and temperature.

15. The process for the manufacture of a first and second decorative resin panel of claim 11, wherein the process further comprises disassembling the layup assembly by removing the second decorative resin panel and the third decorative resin panel from the first decorative resin panel.

16. The process for the manufacture of a first and second decorative resin panel of claim 11, wherein:
the thermoplastic substrate has a thickness of at least about 1/32″ to about 1″; and
the thin, thermoplastic coating substrate and the second thin, thermoplastic coating substrate each has a thickness of at least about 1/32″ to about 1″.

17. A method of laminating decorative objects in a surface of a resin panel, the method comprising:
preparing a layup assembly by positioning opposing first and second thermoplastic, thin, coating substrates around decorative objects, and further surrounding the opposing first and second, thin, thermoplastic coating substrates with opposing first and second outer layers, respectively,
wherein the opposing first and second, thin, thermoplastic coating substrates have a thickness of at least about 1/32″ to about 1″;
processing the layup assembly such that the first and second, thin, thermoplastic coating substrates melt around and form to the shape of the decorative objects,
wherein at least one surface of the decorative resin panel has a variable, high relief tactile feature that corresponds to a shape of the decorative objects; and
disassembling the layup assembly by removing the opposing first and second outer layers from the decorative resin panel,
wherein the decorative resin panel has a thickness of at least about 1/16″ to 2″, a length of at least about 3′ to about 5′, and a width of at least about 5′ to about 10′.

18. The method of claim 17, wherein:
the layup assembly further comprises a thermoplastic substrate positioned between the opposing first and second, thin, thermoplastic coating substrates;
the thermoplastic substrate has a thickness of at least about 1/32″ to about 1″;
the thermoplastic substrate has a first side and a second side; and
the decorative objects are positioned on the first side and the second side of the thermoplastic substrate.

19. The method of claim 18, wherein:
processing the layup assembly causes the first thin, thermoplastic coating substrate to bond to the first side of the thermoplastic substrate around the decorative objects, and the second, thin, thermoplastic coating substrate to bond to the second side of the thermoplastic substrate around the decorative objects; and
the shape of the decorative objects is displayed on a first and second outside surface of the decorative resin panel by virtue of the opposing first and second, thin, thermoplastic coating substrates melting around and forming to the shape of the decorative objects.

20. The method of claim 19, wherein:
the opposing first and second outer layers comprise a thermoplastic material;
the layup assembly further comprises a release film or coating layer positioned directly between the first, thin, thermoplastic coating substrate and the first outer layer, and a second release film or coating layer positioned directly between the second, thin, thermoplastic coating substrate and the second outer layer; and
the first release film or coating layer prevents the first, thin, thermoplastic coating substrate from bonding to the first outer layer, and the second release film or coating layer prevents the second, thin, thermoplastic coating substrate from bonding to the second outer layer.
